(19) United States
(12) Patent Application Publication
(10) Pub. No.: US 2017/0171128 A1
(43) Pub. Date: Jun. 15, 2017

(54) METHOD AND ELECTRONIC DEVICE FOR EMAIL PROCESSING

(71) Applicants: Le Holdings (Beijing) Co., Ltd., Beijing (CN); Lemobile Information Technology (Beijing) Co., Ltd., Beijing (CN)

(72) Inventor: Xunhu GUI, Beijing (CN)

(21) Appl. No.: 15/250,874

(22) Filed: Aug. 29, 2016

Related U.S. Application Data
(63) Continuation of application No. PCT/CN2016/088910, filed on Jul. 6, 2016.

(30) Foreign Application Priority Data
Dec. 12, 2015 (CN) 201510921367.1

(51) Int. Cl. H04L 12/58

(52) U.S. Cl. CPC H04L 51/16; H04L 51/22; H04L 51/08

(57) ABSTRACT

Disclosed are a method and an electronic device for email processing. The method includes: at an electronic device, determining an original subject of an email in a predetermined file folder of an email account, the original subject being a subject of an original email corresponding to the email; determining a plurality of emails with the same original subject to be emails with the same subject, such that the emails with the same subject are viewed under the same directory; and determining signatures of the emails with the same subject from email content of the emails with the same subject, to remove the signatures of the emails with the same subject when displaying the emails with the same subject. In this way, convenience and efficiency in user's reading of emails are improved.

### CROSS REFERENCE TO RELATED APPLICATIONS

This disclosure is a continuation of International Application No. PCT/CN2016/088910, filed on Jul. 6, 2016, which claims priority to Chinese Patent Application No. 201510921367.1, filed on Dec. 12, 2015, the entire contents of which are incorporated herein by reference.

### TECHNICAL FIELD

The disclosure relates to the technical field of emails, and more particularly, to a method and an electronic device for email processing.

### BACKGROUND

In the era of the Internet, emails have replaced paper letters and become an indispensable part in email communications. Any devices capable of connecting to the network may send and receive emails. In addition, regardless of whether the network is a cellular network, there are a plurality of types of devices which are capable of sending and receiving emails, including computers, mobile terminals, for example, mobile phones, PADs, wearable devices and the like. It should be understood that no matter which terminal is used, processing of the emails may be similar.

For example, taking mobile devices as an example, mobile phones nowadays are used by people as necessities, and within a drastic increase of the number of smart phones, functions of the mobile phone are not still restricted to making calls, sending and receiving short messages and the like basic functions, the mobile officing function of the smart terminals is gradually prominent. Convenience and practicability of mobile phone emails are fascinating commercial and business persons who need to search for in real time and intelligently in thousands of emails each day.

It is very convenient to receive and send emails over a mobile device, and a user may check, edit and send emails anytime and anywhere. However, in the related art, each email is individual, and all the emails are displayed in a list form in a mobile phone mailbox in the related art.

In practice, a plurality of emails is generated by means of forwarding and replying the same email, and the email based on which reply and forwarding are conducted is referred to as an original email, the forward or reply operation is based on the initial email, or further forward or reply operations are performed for multiple times based on the forwarded or replied emails. These emails are contextually linked to each other in terms of content, but are inconvenient to be checked. This is because each email is separated and individual, and when the emails with the same subject and relevant content are to be checked, various relevant emails need to be checked by means of frequent switching there between. Finding an email is time and labor consuming, and it is inconvenient to find a relationship between various emails focusing the same subject. With the email processing method in the related art, a user would find it difficult to find relevant emails when finding emails, which consumes much time and causes poor user experience.

In addition, since in the related art, the emails forwarded or replied based on the same email may not be all exhibited, during exhibition of email content, all the content of the email is almost exhibited. Moreover, most users develop their customized signatures in the emails.

With respect to email content exhibition, the mobile phone mailbox generally directly exhibits email content acquired from an email server on the page of the mailbox without processing the email content.

With respect to the user, when the user receives an email sent by another user, content of the email may be checked if the signature of the email is short. However, in case of some users who pursue personality and customization, the signature would be generally very long and the content of the signature is redundant. As a result, the entire screen displays the signature, but has not margin to display the content of the email, which increases reading difficulty for the user.

### SUMMARY

Embodiments of the present disclosure provide an email processing method and device, to solve the problem in the related art that more signatures of emails are displayed and thus efficiency in reading emails by a user is low, and improve convenience and efficiency in user's reading of emails.

An embodiment of the present disclosure provides an email processing method, including: determining an original subject of an email in a predetermined file folder of an email account, the original subject being a subject of an original email corresponding to the email; determining a plurality of emails with the same original subject as emails with the same subject, such that the emails with the same subject are viewed under the same directory; and determining signatures of the emails with the same subject from email content of the emails with the same subject, to remove the signatures of the emails with the same subject when displaying the emails with the same subject.

An embodiment of the present disclosure provides an email processing device, including: at least one processor; and a memory communicably connected with the at least one processor for storing instructions executable by the at least one processor, wherein execution of the instructions by the at least one processor causes the at least one processor to: determine an original subject of an email in a predetermined file folder of an email account, the original subject being a subject of an original email corresponding to the email; determine a plurality of emails with the same original subject as emails with the same subject, such that the emails with the same subject are viewed under the same directory; and determine signatures of the emails with the same subject from email content of the emails with the same subject, to remove the signatures of the emails with the same subject when displaying the emails with the same subject.

An embodiment of the present disclosure further provides a non-transitory computer-readable storage medium storing executable instructions that, when executed by an electronic device, cause the electronic device to: determine an original subject of an email in a predetermined file folder of an email account, the original subject being a subject of an original email corresponding to the email; determine a plurality of emails with the same original subject to be emails with the same subject, such that the emails with the same subject are viewed under the same directory; and determine signatures of the emails with the same subject from email content of the emails with the same subject, to remove the signatures of the emails with the same subject when displaying the emails with the same subject.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating an email processing method according to one embodiment of the present disclosure;

FIG. 2 is a flowchart illustrating an email processing method according to another embodiment of the present disclosure;

FIG. 3 is a flowchart illustrating an email processing method according to still another embodiment of the present disclosure;

FIG. 4 is a flowchart illustrating an email processing method according to yet another embodiment of the present disclosure;

FIG. 5 is a diagram illustrating a comparison of effects in displaying email content with signatures removed and with signatures not removed according to one embodiment of the present disclosure;

FIG. 6 is a schematic structural diagram illustrating an email processing device according to one embodiment of the present disclosure;

FIG. 7 is a schematic structural diagram illustrating an email processing device according to another embodiment of the present disclosure;

FIG. 8 is a schematic structural diagram illustrating an email processing device according to still another embodiment of the present disclosure;

FIG. 9 is a schematic structural diagram illustrating an email processing device according to yet still another embodiment of the present disclosure; and

FIG. 10 is a schematic structural diagram illustrating an electronic device according to the present disclosure.

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

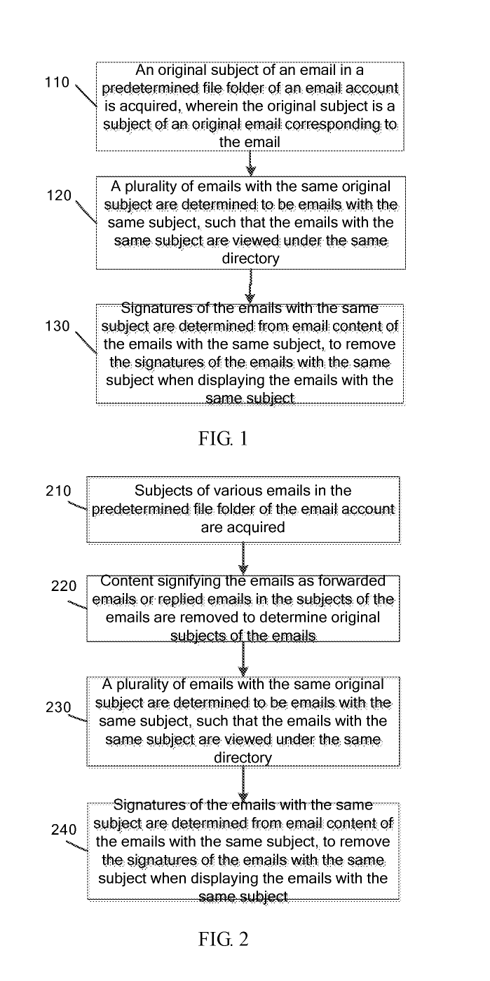

FIG. 1 is a flowchart illustrating an email processing method according to one embodiment of the present disclosure. As illustrated in FIG. 1, the email processing method according to the present disclosure includes the following steps:

Step 110: An original subject of an email in a predetermined file folder of an email account is acquired, wherein the original subject is a subject of an original email corresponding to the email.

Emails may be categorized into original emails and non-original emails. When a user writes a new email and sends the email, this email is an original email. When another user receives this email, the received email is also the original email. A plurality of emails are generated by means of forwarding and replying the original email, the forward or reply operation is based on the initial email, or further forward or reply operations are performed for multiple times based on the forwarded or replied emails. These emails are non-original emails.

Each email has its own subject portion or content portion. The subject of the email is sometimes referred to as a header. With respect to an email, the subject portion and the content portion thereof may be differentiated according to the relate dart. The present disclosure does not define how to determine the subject of email and the content of the email.

In this step, the subject of each email of the email account may be acquired according to the related art. It should be understood that when an email is an original email, since the email is not subjected to no reply, forward or the like operation, the subject of the email is an original subject. When an email is a forwarded email or a replied email, the subject of the email includes the subject of the original email, and a forward or reply identifier thereof. It should be understood that depending on the forward or reply operations and times, the occurrence times of the forward or reply identifier is different. These identifiers are not present in the subject of the original email, which, thus, do not pertain to the original subject of the email.

It should be understood that there are multiple types of identifiers identifying that the email is a replied email. In this step, the identifier indicating that the email is a forwarded or replied email may be removed according to the subject of the email, such that the original subject of the email is determined. Alternatively, the original subject of the email may be extracted according to whether the email is an original email or a non-original email.

Step 120: A plurality of emails with the same original subject are determined to be emails with the same subject, such that the emails with the same subject are viewed under the same directory.

In step 110, the original subjects of the emails are determined. It should be understood that the plurality of emails with the same original subject are practically relevant discussions with respect to the same original email. In an email account, a plurality of original subjects may be present. For example, if emails 1, 3 and 5 have the same original subject, and emails 2, 4 and 6 have the same original subjects, then it is determined that emails 1, 3 and 5 are a group of emails with the same subject, and emails 2, 4 and 6 are a group of emails with the same subject. The embodiment of the present disclosure is described with respect to a group of emails with the same subject. In practical operation, implementation manner for each group of emails with the same subject may be similar.

In this step, the plurality of emails with the same original subject are determined to be the emails with the same subject. As such, when the emails are displayed, the emails with the same subject may be merged into the same email directory. It should be understood that an email directory refers to an item in an email list. In this step, the subject emails are merged under the same email directory. The emails with the same subject may be operated by operating the email directory. When the user performs an operation for the email directory, the user may find all the emails with the same subject under this email directory.

Step 130: Signatures of the emails with the same subject are determined from email content of the emails with the same subject, to remove the signatures of the emails with the same subject when displaying the emails with the same subject.

Email content generally includes an email content body portion and an email signature portion. Different email body portions greatly vary due to different content discussed in the emails. However, the email signature portion would include relatively fixed content, for example, telephone number, address, department and the like of the sender. In addition, the signature of the email is generally present at the end of the email content.

In this step, the signature of the email may be judged according to the location of the email signature and commonly used keyword. As such, the signatures of the emails with the same subject are determined from the email content of the emails with the same subject. During displaying of the emails, the signatures of the emails may be removed to only display the email content body portions.

According to the embodiment of the present disclosure, original subjects of emails are determined, emails with the same original subject are determined to be emails with the same subject, and signatures of the emails with the same subject are acquired, such that the signatures are removed when the emails with the same subject are displayed, and thus the email content body portions are only displayed. In this way, convenience and efficiency in user's of reading are improved, and meanwhile utilization rate of the screen is also enhanced.

FIG. 2 is a flowchart illustrating an email processing method according to another embodiment of the present disclosure. As illustrated in FIG. 2, the email processing method according to the present disclosure includes the following steps:

Step 210: Subjects of various emails in the predetermined file folder of the email account are acquired.

When a user firstly sends an email which is an original email, the subject and content of this email are both determined by the user. When discussions are made with respect to this original email, the subjects of the emails sent would change. For example, when a user receiving the original email replies this email, such fields as “reply”, “re” or “re” or the like may be automatically added to the subject of the replied email. These fields are used for identifying that this email is a replied email based on the original email. Still for example, when a user receiving the original email forwards this email, such fields as “forward”, “fwd” or “FWD” or the like may be automatically added to the subject of the replied email. These fields are used for identifying that this email is a replied email based on the original email. With respect to the identifier fields identifying the replied email or the forwarded email, the related art or any future possible method may be applied, which is not limited in the embodiment of the present disclosure.

The original email may be replied for multiple times or forwarded for multiple times, or be replied and forward once or for multiple times. For example, if an email is replied for multiple times, a plurality of identifiers “re” may be added to the subject of the email; if an email is forwarded for multiple times, a plurality of identifiers “fwd” are automatically added to the subject of the email; and if an email is forwarded and replied, an identifier of “re” and an identifier “fwd” are both automatically added to the subject of the email.

With respect to the original email, the subject input by the user is the subject of the email. An email which is replied or forwarded indicates that the identifier indicating reply or forwarding, together with the subject of the original email, forms the subject of the forwarded or replied email.

For example, when the subject of an original email is “EUI_Daily_XXXX”, if another user replies this email, the subject of this email changes to “re:EUI_Daily_XXXX”; and if another user forwards this email, the subject of this email changes to “fwd:EUI_Daily_XXXX”.

Step 220: Content signifying the emails as forwarded emails or replied emails in the subjects of the emails are removed to determine original subjects of the emails.

In this step, the identifier content indicating that the email is a forwarded or replied email is removed from the subject of the email, and then the original subject of the email may be determined.

For example, following the example in step 210, the subject of the original email is “EUI_Daily_XXXX”. That is, the subject “EUI_Daily_XXXX” of the original email is the original subject. When another user replies this email, the subject matter of this email changes to “re:EUI_Daily_XXXX”, and the identifier “re:” indicating that the email is a replied email is removed. As such, it is determined that the original subject of the email is “EUI_Daily_XXXX”, and the subject of the replied email is the subject of the original email which is replied. Likewise, when another user forwards this email, the subject of this email changes to “fwd:EUI_Daily_XXXX”. The identifier “fwd:” indicating the forwarded content therein is removed, and thus the original subject “EUI_Daily_XXXX” of this forwarded email is acquired. It should be noted that when an email is replied or forwarded for multiple times, a plurality of identifiers “fwd” and/or “re” are added to the subject of the email. In this case, the identifiers indicating email reply and/or forwarding need to be removed to acquire the original subject.

It should be noted that the specific content included by the content to be removed may be predetermined. For example, it may be defined in an enumeration manner which content is to be removed. For example, in an email, the identifiers indicating reply and forwarding may be embodied in a plurality of expressions. These expressions may be identified as content to be removed from the subject. The expressions indicating reply include such fields as “reply”, “re”, “Re” or the like, and the expressions indicating forwarding include such fields as “fwd”, “FWD”, forward” or the like.

In addition, some symbols may also be combined with the above fields indicating reply or forwarding, for example, colons. It should be noted that during enumeration, different languages and different expressions may be fully considered. For example, colons are full-width colons and half-width colons, which may all be predetermined to be the content to be removed.

Step 230: A plurality of emails with the same original subject are determined to be emails with the same subject, such that the emails with the same subject are viewed under the same directory.

In this step, the plurality of emails with the same original subject as the emails with the same subject, such that the emails with the same subject are checked under the same directory. The specific operations may be referenced to step 120 in the embodiment illustrated in FIG. 1.

Step 240: Signatures of the emails with the same subject are determined from email content of the emails with the same subject, to remove the signatures of the emails with the same subject when displaying the emails with the same subject.

In this step, the signatures of the emails with the same subject are determined from the email content of the emails with the same content, such that the signatures are removed while the emails with the same subject are displayed. The specific operations may be referenced to step 130 in the embodiment illustrated in FIG. 1.

According to the embodiment of the present disclosure, an identifier indicating that an email is a forwarded email or a replied email is removed from the subject of the email, and thus an original subject of the email is determined; emails with the same original subject are determined to be email with the same subject, and signatures of the emails with the same subject are acquired, such that the signatures are removed when the emails with the same subject are displayed. In this way, convenience and efficiency in user's of reading are improved, and meanwhile utilization rate of the screen is also enhanced.

The embodiment of the present disclosure further includes:

The original subjects of the emails with the same subject are stored. In this step, the original subjects of the emails with the same subject are stored, for the convenience of searching for the same original subject in the file folder. For example, when a new email is detected, an original subject of this new email is directly acquired, and then compared with the stored original subjects. If the original subject of the new email is consistent with any of the stored original subjects, the new email is directly determined to be the emails with the same emails.

For example, in the predetermined file folder, there may be a plurality of original subjects, for example, an original subject 1, an original subject 2 and an original subject 3. In this step, these original subjects may be stored.

According to the embodiment of the present disclosure, the original subjects of the emails with the same subject are stored for convenience of comparison. As such, a new email with the same subject may be rapidly determined, and thus user experience is improved.

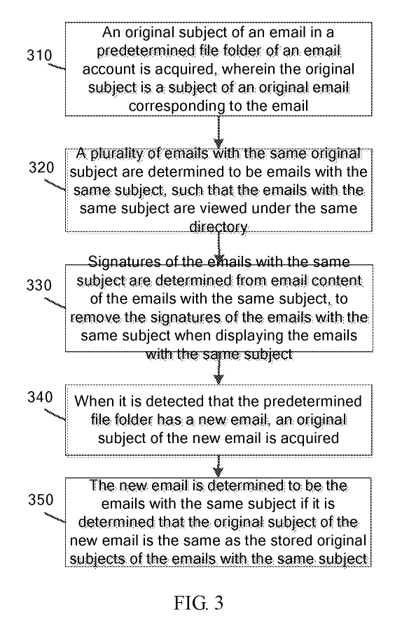

FIG. 3 is a flowchart illustrating an email processing method according to still another embodiment of the present disclosure. As illustrated in FIG. 3, the email processing method according to the present disclosure includes the following steps:

Step 310: An original subject of an email in a predetermined file folder of an email account is acquired, wherein the original subject is a subject of an original email corresponding to the email.

In this step, the original subjects of emails in the predetermined file folder of the email account are acquired, wherein the original subjects are subjects of original emails corresponding to the emails. The specific operations may be referenced to step 110 in the embodiment illustrated in FIG. 1.

Step 320: A plurality of emails with the same original subject are determined to be emails with the same subject, such that the emails with the same subject are viewed under the same directory.

In this step, the plurality of emails with the same original subject as the emails with the same subject, such that the emails with the same subject are checked under the same directory. The specific operations may be referenced to step 120 in the embodiment illustrated in FIG. 1.

Step 330: Signatures of the emails with the same subject are determined from email content of the emails with the same subject, to remove the signatures of the emails with the same subject when displaying the emails with the same subject.

In this step, the signatures of the emails with the same subject are determined from the email content of the emails with the same content, such that the signatures are removed while the emails with the same subject are displayed. The specific operations may be referenced to step 130 in the embodiment illustrated in FIG. 1.

Step 340: When it is detected that the predetermined file folder has a new email, an original subject of the new email is acquired.

In this step, it may be detected using any related art that the predetermined file folder has a new email. For example, when a new email is received, the new email is present in the inbox. In an email account, when an email is sent, the outbox has also a new email and the like, which is not described herein any further in the embodiment of the present disclosure. When it is detected that the predetermined file folder has a new email, the original subject of the new email may be acquired in a manner in step 110 illustrated in FIG. 1.

Step 350: The new email is determined to be the emails with the same subject if it is determined that the original subject of the new email is the same as the stored original subjects of the emails with the same subject.

The original subject of the new email acquired in step 340 is compared with the original subjects of the stored emails with the same subject. It should be understood that in the predetermined file folder, a plurality of original subjects may be present, that is, a plurality of groups of emails with the same subject. In this case, the original subject of the email may be respectively compared with the stored plurality of original subjects. If the original subject of the new email is the same as any of the stored original subjects of the group of emails with the same subject, the new email is determined to be the emails with the same subject.

For example, the stored original subjects of the emails with the same subject include an original subject 1, an original subject 2 and an original subject 3. If the original subject of the new email is the same as the original subject 2, it is determined that the new email is determined to be one in the group of emails with the same subject corresponding to the original subject 2.

According to the embodiment of the present disclosure, the original subject of a new email is compared with the stored original subjects, such that it is quickly determined whether the new email falls pertains to an existing email with the same subject. In this way, speed and accuracy are improved.

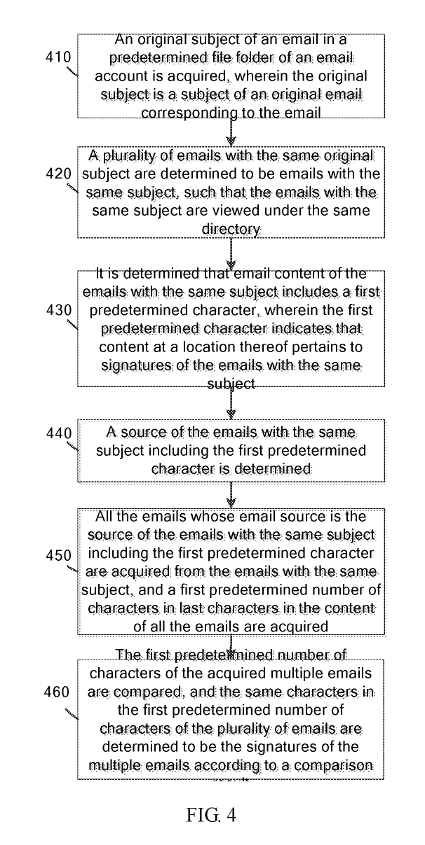

FIG. 4 is a flowchart illustrating an email processing method according to yet another embodiment of the present disclosure. As illustrated in FIG. 4, the email processing method according to the present disclosure includes the following steps:

Step 410: An original subject of an email in a predetermined file folder of an email account is acquired, wherein the original subject is a subject of an original email corresponding to the email.

In this step, the original subjects of emails in the predetermined file folder of the email account are acquired, wherein the original subjects are subjects of original emails corresponding to the emails. The specific operations may be referenced to step 110 in the embodiment illustrated in FIG. 1.

Step 420: A plurality of emails with the same original subject are determined to be emails with the same subject, such that the emails with the same subject are viewed under the same directory.

In this step, the plurality of emails with the same original subject as the emails with the same subject, such that the emails with the same subject are checked under the same directory. The specific operations may be referenced to step 120 in the embodiment illustrated in FIG. 1.

Step 430: It is determined that email content of the emails with the same subject includes a first predetermined character, wherein the first predetermined character indicates that content at a location thereof pertains to signatures of the emails with the same subject.

As described above, the signature of the email generally includes some specific characters. For example, the user may add contact information such as address, telephone number and the like at the location of the signature, or write the post, department and the like of the user. In case of address, the contact information may be written as “Address: Room xxx, No. xxx, xxx Road”; in case of telephone number, the contact information may be written as “Contact telephone”, “Telephone”, “Mobile phone number” or “Fixed-line telephone number” plus a string of digits. Alternatively, other contact information may be included, for example, WeChat account, QQ account and the like. The first predetermined character may be set according to the content included in the signature. It should be understood that although the user may write the contact information as “Address: Room xxx, No. xxx, xxx Road”, during setting of the first predetermined character, each of “Address”, “Road”, “No.” and “Room” may be set as an independent first predetermined character, and it may be determined that the characters are content of the signature as long as one or more of these characters are set. Alternatively, the characters may also be set as a combination of texts and digits. For example, several characters are placed before “Road”, and these characters are also considered to be the content of the signature. Regardless of what combination, as long as the signature generally involves such combination of expressions, the combination may be considered to be the first predetermined character. Once the character is found, it may be considered that the character pertains to the content of the signature of the email.

In addition, since the signature is generally added at the end of the email, the location of the first predetermined character in the content of the email may be set. A search may be made in a predetermined number of characters at the end of the email to check whether these characters are included. If such characters are not found at the end of the email, it is definitely determined that the email content of the emails with the same subject includes the first predetermined character. The first predetermined character indicates that the content at the location thereof pertains to the signatures of the emails with the same subject.

Step 440: A source of the emails with the same subject including the first predetermined character is determined.

In step 430, it is determined that an email with the same subject includes a signature portion; and in step 440, the source of the email is determined, which is generally the sender of the email. The sender of an email may be queried according to the related art, which is not limited in the embodiment of the present disclosure.

Step 450: All the emails whose email source is the source of the emails with the same subject including the first predetermined character are acquired from the emails with the same subject, and a first predetermined number of characters in last characters in the content of all the emails are acquired.

In this step, all the emails with the same source as that of the emails determined in step 440 are found in the emails with the same subject. For example, all the emails whose sender is the same as the sender determined in step 440 are found in the emails with the same subject, which may also be implemented according to the related art. It should be understood that the same sender generally has the same signature. In step 430, in the embodiment of the present disclosure, it is determined that signatures exist in the emails. However, in step 450, all the emails sent by the sender of the email with a signature in step 430 are further queried, to check whether these emails have a signature.

After the emails with the same source are found, a first predetermined number of characters in last characters in the content of all the emails are acquired. Since a signature generally occupies a specific number of characters at the end of an email, a last portion of characters in the email may be searched. The number of characters to be searched may be predetermined, which may be determined according to the number of characters occupied by a general signature or may be assigned with a margin.

Step 460: The first predetermined number of characters of the acquired multiple emails are compared, and the same characters in the first predetermined number of characters of the plurality of emails are determined to be the signatures of the multiple emails according to a comparison result.

The first predetermined number of characters in the plurality of emails acquired in step 450 are compared to check whether identical characters are present in these characters. Since the source of the emails with the same subject is acquired in step 450, for example, emails from the same sender, the signatures of these emails are also the same. That is, last portions of the content of these emails have a specific number of identical characters.

According to the embodiment of the present disclosure, the first predetermined number of characters of the acquired plurality of emails are compared, and if the comparison result indicates that these compared characters have the identical characters, these characters are determined to be the signatures of the email according to the comparison result.

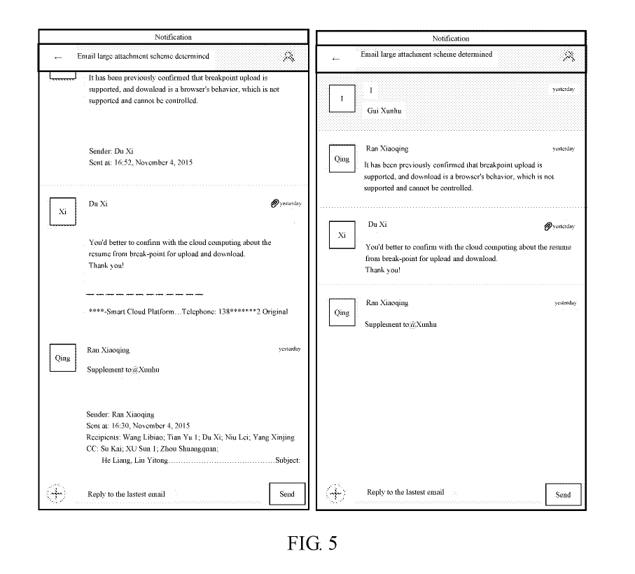

FIG. 5 is a diagram illustrating a comparison of effects in displaying email content with signatures removed and with signatures not removed according to one embodiment of the present disclosure. In FIG. 5, the left part is a schematic diagram illustrating displaying of all the content of emails, and the left part is a schematic diagram illustrating an effect in displaying the email content with signatures removed. A group of emails with the same subject are discussions about the same original email, and thus removing signatures makes displaying of the entire email clear and brief.

In this embodiment, it is determined whether a portion identifying a signature is present in content of an email; if such a portion is present, a source of the email is acquired, emails with the same source as the source of the email are acquired, last portions of characters of these emails are acquired, and the last portions of characters are compared; and if there are identical portions in these characters, the identical portions are determined as the signature portion, such that the signature portion may be removed when email content is displayed. According to this embodiment, the signature portion of an email may be more accurately determined, and thus user experience is more intelligently improved.

FIG. 6 is a flowchart illustrating an email processing device according to one embodiment of the present disclosure. As illustrated in FIG. 6, the email processing device according to the present disclosure includes: a first determining module 610, a second determining module 620, and a third determining module 630.

The first determining module 610 is configured to determine an original subject of an email in a predetermined file folder of an email account, wherein the original subject is a subject of an original email corresponding to the email.

The first determining module 610 may acquire the subject of each email of the email account according to the related art. It should be understood that when an email is an original email, since the email is not subjected to no reply, forward or the like operation, the subject of the email is an original subject. When an email is a forwarded email or a replied email, the subject of the email includes the subject of the original email, and a forward or reply identifier thereof. In this case, the identifier indicating that the email is a forwarded or replied email may be removed according to the subject of the email, such that the original subject of the email is determined.

The second determining module 620 is configured to determine a plurality of emails with the same original subject to be emails with the same subject, such that the emails with the same subject are viewed under the same directory.

In an email account, there are may be a plurality of groups of original subjects. The second determining module 620 determines a plurality of emails with the same original subject to be the emails with the same subject. It should be understood that in a file folder under an email account, there may be a plurality of original subjects, such that a plurality of groups of emails with the same subject may be present accordingly. The second determining module 620 is configured to determine a plurality of emails with the same original subject to be emails with the same subject, such that the emails with the same subject are viewed under the same directory. It should be understood that an email directory refers to an item in an email list. Herein, the subject emails are merged under the same email directory. The emails with the same subject may be operated by operating the email directory. When the user performs an operation for the email directory, the user may find all the emails with the same subject under this email directory.

The third determining module is configured to determine signatures of the emails with the same subject from email content of the emails with the same subject, to remove the signatures of the emails with the same subject when displaying the emails with the same subject.

Email content generally includes an email content body portion and an email signature portion. Different email body portions greatly vary due to different content discussed in the emails. However, the email signature portion would include relatively fixed content, for example, telephone number, address, department and the like of the sender. In addition, the signature of the email is generally present at the end of the email content.

The third determining module 630 may judge the signature of the email according to the location of the email signature and commonly used keyword. As such, the signatures of the emails with the same subject are determined from the email content of the emails with the same subject. During displaying of the emails, the signatures of the emails may be removed to only display the email content body portions.

According to the embodiment of the present disclosure, original subjects of emails are determined, emails with the same original subject are determined to be emails with the same subject, and signatures of the emails with the same subject are acquired, such that the signatures are removed when the emails with the same subject are displayed, and thus the email content body portions are only displayed. In this way, convenience and efficiency in user's of reading are improved, and meanwhile utilization rate of the screen is also enhanced.

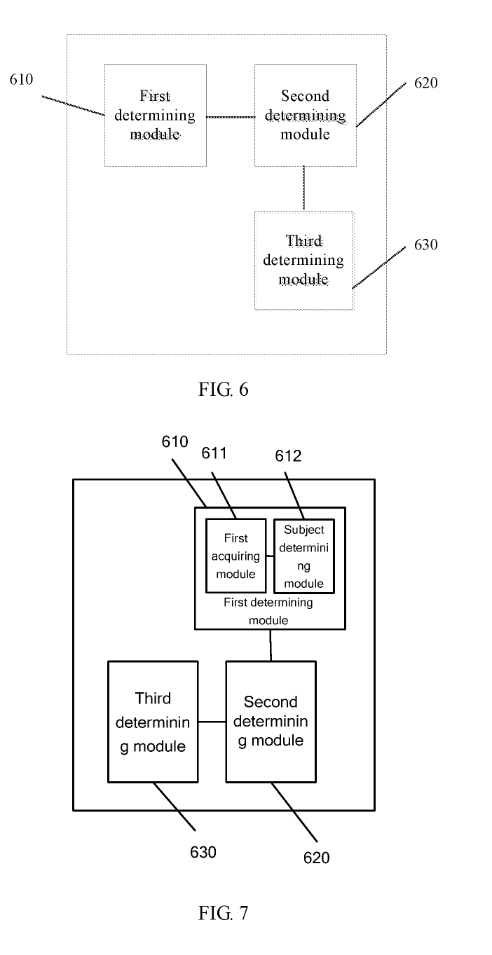

FIG. 7 is a flowchart illustrating an email processing device according to another embodiment of the present disclosure. As illustrated in FIG. 7, the email processing device according to the present disclosure includes: a first determining module 610, a second determining module 620, and a third determining module 630. Specific implementation of the modules may be referenced to the corresponding description in the embodiment illustrated in FIG. 6. The first determining module 610 includes:

a first acquiring module 611, configured to acquire subjects of various emails in the predetermined file folder of the email account; and

with respect to the original email, the subject input by the user is the subject of the email; an email which is replied or forwarded indicates that the identifier indicating reply or forwarding, together with the subject of the original email, forms the subject of the forwarded or replied email; a first acquiring module 611, configured to acquire subjects of various emails in the predetermined file folder of the email account; and

a subject determining module 612, configured to remove contents signifying the emails as forwarded emails or replied emails in the subjects of the emails to determine original subjects of the emails.

When a user firstly sends an email which is an original email, the subject and content of this email are both determined by the user. When discussions are made with respect to this original email, the subjects of the emails sent would change. For example, when a user receiving the original email replies this email, such fields as “reply”, “re” or “re” or the like may be automatically added to the subject of the replied email. These fields are used for identifying that this email is a replied email based on this email. Still for example, when a user receiving the original email forwards this email, such fields as “forward”, “fwd” or “FWD” or the like may be automatically added to the subject of the replied email. These fields are used for identifying that this email is a replied email based on the original email. With respect to the identifier fields identifying the replied email or the forwarded email, the related art or any future possible method may be applied, which is not limited in the embodiment of the present disclosure.

The original email may be replied for multiple times or forwarded for multiple times, or be replied and forward once or for multiple times. For example, if an email is replied for multiple times, a plurality of identifiers “re” may be added to the subject of the email; if an email is forwarded for multiple times, a plurality of identifiers “fwd” are automatically added to the subject of the email; and if an email is forwarded and replied, an identifier of “re” and an identifier “fwd” are both automatically added to the subject of the email.

The subject determining module 612 removes the identifier content indicating that the email is a forwarded or replied email from the subject of the email, and then determine the original subject of the email.

With the email processing method and device according to the embodiments of the present disclosure, original subjects of emails are determined, emails with the same original subject are determined to be emails with the same subject, and signatures of the emails with the same subject are acquired, such that the signatures are removed when the emails with the same subject are displayed. In this way, convenience and efficiency in user's of reading are improved, and meanwhile utilization rate of the screen is also enhanced.

Specifically, according to the embodiment of the present disclosure, the email processing device may further include a storing module, configured to store the original subjects of the emails with the same subject. For example, the storing module stores the original subjects of the emails with the same subject, for the convenience of searching for the same original subject in the file folder. For example, in the predetermined file folder, there may be a plurality of original subjects, for example, an original subject 1, an original subject 2 and an original subject 3. In this step, these original subjects may be stored.

According to the embodiment of the present disclosure, the original subjects of the emails with the same subject are stored for convenience of comparison. As such, a new email with the same subject may be rapidly determined, and thus user experience is improved.

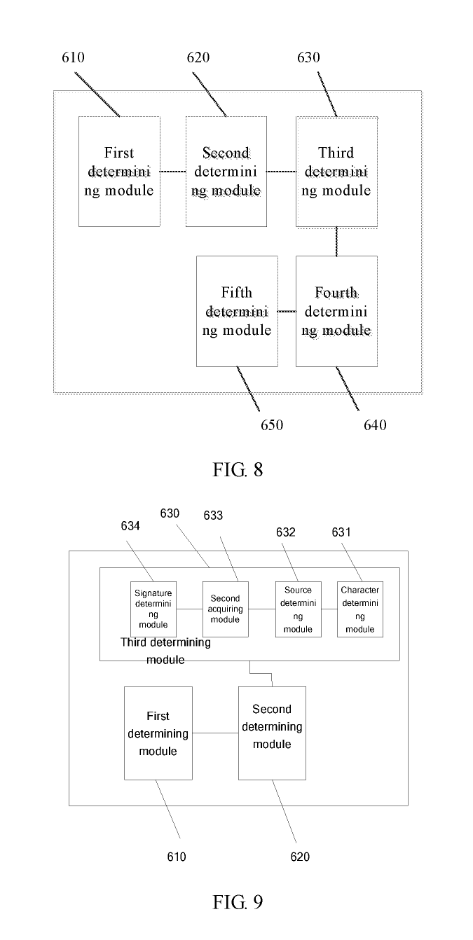

FIG. 8 is a schematic structural diagram illustrating an email processing device according to still another embodiment of the present disclosure. As illustrated in FIG. 8, the email processing device according to the present disclosure includes: a first determining module 610, a second determining module 620, and a third determining module 630. Specific implementation of the modules may be referenced to the corresponding description in the embodiment illustrated in FIG. 6. The email processing device further includes:

a fourth determining module 640, configured to, when it is detected that the predetermined file folder has a new email, determine an original subject of the new email; and

it may be detected using any related art that the predetermined file folder has a new email; for example, when a new email is received, the new email is present in the inbox; in an email account, when an email is sent, the outbox has also a new email and the like, which is not described herein any further in the embodiment of the present disclosure; when it is detected that the predetermined file folder has a new email, the original subject of the new email may be acquired according to the method employed by the first determining module 610 illustrated in FIG. 6; and

a fifth determining module 650, configured to determine the new email to be the emails with the same subject if it is determined that the original subject of the new email determined by the fourth determining module is the same as the stored original subjects of the emails with the same subject stored by the storing module.

The original subject of the new email acquired by the fourth determining module 640 is compared with the original subjects of the stored emails with the same subject. It should be understood that in the predetermined file folder, a plurality of original subjects may be present, that is, a plurality of groups of emails with the same subject. In this case, the original subject of the email may be respectively compared with the stored plurality of original subjects. If the original subject of the new email is the same as any of the stored original subjects of the group of emails with the same subject, the new email is determined to be the emails with the same subject.

According to the embodiment of the present disclosure, the original subject of a new email is compared with the stored original subjects, such that it is quickly determined whether the new email falls pertains to an existing email with the same subject. In this way, speed and accuracy are improved.

FIG. 9 is a schematic structural diagram illustrating an email processing device according to yet still another embodiment of the present disclosure. As illustrated in FIG. 9, the email processing device according to the present disclosure includes: a first determining module 6140, a second determining module 620, and a third determining module 630. Specific implementation of the modules may be referenced to the corresponding description in the embodiment illustrated in FIG. 6. The third determining module 630 includes:

a character determining module 631, configured to determine that email content of the emails with the same subject includes a first predetermined character, the first predetermined character indicating that content at a location thereof being signatures of the emails with the same subject;

as described above, the signature of the email generally includes some specific characters; for example, the user may add contact information such as address, telephone number and the like at the location of the signature, or write the post, department and the like of the user; in case of address, the contact information may be written as “Address: Room xxx, No. xxx, xxx Road”; in case of telephone number, the contact information may be written as “Contact telephone”, “Telephone”, “Mobile phone number” or “Fixed-line telephone number” plus a string of digits; alternatively, other contact information may be included, for example, WeChat account, QQ account and the like; a first predetermined character may be set according to the content included in the signature; it should be understood that although the user may write the contact information as “Address: Room xxx, No. xxx, xxx Road”, during setting of the first predetermined character, each of “Address”, “Road”, “No.” and “Room” may be set as an independent first predetermined character, and it may be determined that the characters are content of the signature as long as one or more of these characters are set; alternatively, the characters may also be set as a combination of texts and digits; for example, several characters are placed before “Road”, and these characters are also considered to be the content of the signature; regardless of what combination, as long as the signature generally involves such combination of expressions, the combination may be considered to be the first predetermined character; once the character is found, the character determining module 631 may consider that the character pertains to the content of the signature of the email;

in addition, since the signature is generally added at the end of the email, the location of the first predetermined character in the content of the email may be set; a search may be made in a predetermined number of characters at the end of the email to check whether these characters are included; if such characters are not found at the end of the email, it is definitely determined that the email content of the emails with the same subject includes the first predetermined character; the first predetermined character indicates that the content at the location thereof pertains to the signatures of the emails with the same subject;

a source determining module 632, configured to determine a source of the emails with the same subject including the first predetermined character;

the character determining module 631 determines that an email with the same subject includes a signature portion; and the source determining module 632 determines the source of the email, which is generally the sender of the email; the sender of an email may be queried according to the related art, which is not limited in the embodiment of the present disclosure;

a second acquiring module 633, configured to acquire all the emails whose email source is the source of the emails with the same subject including the first predetermined character from the emails with the same subject, and acquire a first predetermined number of characters in last characters in the content of all the emails;

wherein the second acquiring module 633 acquires all the emails with the same source as that of the emails determined by the determining module 632 are found in the emails with the same subject; for example, all the emails whose sender is the same as the sender determined by the source determining module 632 are found in the emails with the same subject, which may also be implemented according to the related art; it should be understood that the same sender generally has the same signature; the character determining module 631 determines that a signature exists in the email, and the second acquiring module 633 further determines all the emails sent by the sender of the email with a signature determined by the character determining module 631, to check whether these emails have a signature;

after the emails with the same source are found, a first predetermined number of characters in last characters in the content of all the emails are acquired; since a signature generally occupies a specific number of characters at the end of an email, a last portion of characters in the email may be searched; the number of characters to be searched may be predetermined, which may be determined according to the number of characters occupied by a general signature or may be assigned with a margin; and

a signature determining module 634, configured to compare the first predetermined number of characters of the acquired multiple emails, and determine the same character in the first predetermined number of characters of the plurality of emails as the signatures of the multiple emails according to a comparison result.

The first predetermined number of characters in the plurality of emails acquired by the second acquiring module 633 are compared to check whether identical characters are present in these characters. Since the source of the emails with the same subject is acquired by the second acquiring module 633, for example, emails from the same sender, the signatures of these emails are also the same. That is, last portions of the content of these emails have a specific number of identical characters.

The signature determining module 634 compares the first predetermined number of characters of the acquired plurality of emails, and if the comparison result indicates that these compared characters have the identical characters, these characters are determined to be the signatures of the email.

In this embodiment, it is determined whether a portion identifying a signature is present in content of an email; if such a portion is present, a source of the email is acquired, emails with the same source as the source of the email are acquired, last portions of characters of these emails are acquired, and the last portions of characters are compared; and if there are identical portions in these characters, the identical portions are determined as the signature portion, such that the signature portion may be removed when email content is displayed. According to this embodiment, the signature portion of an email may be more accurately determined, and thus user experience is more intelligently improved.

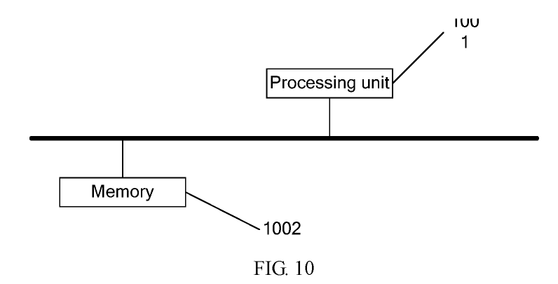

Referring to FIG. 10, another embodiment of the present disclosure further provides an electronic device, which has the same functions as those of the apparatus illustrated in FIG. 6. The device as illustrated in FIG. 10 includes at least one central processing unit 1001 and a memory 1002. The memory 1002 and the at least one central processing unit 1001 are connected via a bus. The memory 1002 is configured to store computer instructions. When the apparatus is executed, the at least one central processing unit 1001 performs the computer instructions stored in the memory to cause the apparatus to perform the steps in the methods as illustrated in FIG. 1. to FIG. 4.

Another embodiment of the present disclosure further provides a non-transitory computer-readable storage medium storing executable instructions that, when executed by an electronic device, cause the electronic device to: determine an original subject of an email in a predetermined file folder of an email account, the original subject being a subject of an original email corresponding to the email; determine a plurality of emails with the same original subject to be emails with the same subject, such that the emails with the same subject are viewed under the same directory; and determine signatures of the emails with the same subject from email content of the emails with the same subject, to remove the signatures of the emails with the same subject when displaying the emails with the same subject.

The above described apparatus embodiments are merely for illustration purpose only. The modules which are described as separate components may be physically separated or may be not physically separated, and the components which are illustrated as modules may be or may not be physical modules, that is, the components may be located in the same position or may be distributed into a plurality of network modules. A part or all of the modules may be selected according to the actual needs to achieve the objectives of the technical solutions of the embodiments. Persons of ordinary skill in the art may understand and implement the present disclosure without paying any creative effort.

According to the above embodiments of the present invention, a person skilled in the art may clearly understand that the embodiments of the present invention may be implemented by means of hardware or by means of software plus a necessary general hardware platform. Based on such understanding, portions of the technical solutions of the present disclosure that essentially contribute to the related art may be embodied in the form of a software product, the computer software product may be stored in a storage medium, such as a ROM/RAM, a magnetic disk, a CD-ROM and the like, including several instructions for causing a computer device (a personal computer, a server, or a network device) to perform the various embodiments of the present disclosure, or certain portions of the method of the embodiments.

It should be finally noted that the above-described embodiments are merely for illustration of the present disclosure, but are not intended to limit the present disclosure. Although the present disclosure is described in detail with reference to these embodiments, a person skilled in the art may also make various modifications to the technical solutions disclosed in the embodiments, or make equivalent replacements to a part of the technical features contained therein. Such modifications or replacement, made without departing from the principles of the present invention, shall fall within the scope of the present disclosure.

What is claimed is:

1. An email processing method at an electronic device, comprising:
determining an original subject of an email in a predetermined file folder of an email account, the original subject being a subject of an original email corresponding to the email;
determining a plurality of emails with the same original subject to be emails with the same subject, such that the emails with the same subject are viewed under the same directory; and
determining signatures of the emails with the same subject from email content of the emails with the same subject, to remove the signatures of the emails with the same subject when displaying the emails with the same subject.

2. The method according to claim 1, wherein the determining an original subject of an email in a predetermined file folder of an email account comprises:
acquiring subjects of various emails in the predetermined file folder of the email account; and
removing content signifying the emails as forwarded emails or replied emails in the subjects of the emails to determine original subjects of the emails.

3. The method according to claim 1, further comprising: storing the original subjects of the emails with the same subject.

4. The method according to claim 3, further comprising:
when it is detected that the predetermined file folder has a new email, acquiring an original subject of the new email; and
determining the new email to be the emails with the same subject if it is determined that the original subject of the new email is the same as the stored original subjects of the emails with the same subject.

5. The method according to claim 1, wherein the determining signatures of the emails with the same subject from email content of the emails with the same subject comprises:
determining that email content of the emails with the same subject comprises a first predetermined character, the first predetermined character indicating that content at a location thereof being signatures of the emails with the same subject;
determining a source of the emails with the same subject comprising the first predetermined character; and
acquiring, from the emails with the same subject, all the emails whose email source is the source of the emails with the same subject comprising the first predetermined character, and acquiring a first predetermined number of characters in last characters in the content of all the emails; and
comparing the first predetermined number of characters of the acquired plurality of emails, and determining, according to a comparison result, the same character in the first predetermined number of characters of the plurality of emails as the signatures of the plurality of emails.

6. An email processing device, comprising:
at least one processor; and
a memory communicably connected with the at least one processor for storing instructions executable by the at least one processor, wherein execution of the instructions by the at least one processor causes the at least one processor to:
determine an original subject of an email in a predetermined file folder of an email account, the original subject being a subject of an original email corresponding to the email;
determine a plurality of emails with the same original subject to be emails with the same subject, such that the emails with the same subject are viewed under the same directory; and
determine signatures of the emails with the same subject from email content of the emails with the same subject, to remove the signatures of the emails with the same subject when displaying the emails with the same subject.

7. The device according to claim 6, wherein the instructions to determine an original subject of an email in a predetermined file folder of an email account cause the at least one processor to:
acquire subjects of various emails in the predetermined file folder of the email account; and
remove content signifying the emails as forwarded emails or replied emails in the subjects of the emails to determine original subjects of the emails.

8. The device according to claim 6, the at least one processor is further caused to:
store the original subjects of the emails with the same subject.

9. The device according to claim 8, the at least one processor is further caused to:
when it is detected that the predetermined file folder has a new email, determine an original subject of the new email; and
determine the new email to be the emails with the same subject if it is determined that the original subject of the new email determined by the fourth determining module is the same as the stored original subjects of the emails with the same subject stored by the storing module.

10. The device according to claim 6, wherein the instructions to determine signatures of the emails with the same subject from email content of the emails with the same subject, to remove the signatures of the emails with the same subject when displaying the emails with the same subject cause the at least processor to:
determine that email content of the emails with the same subject comprises a first predetermined character, the first predetermined character indicating that content at a location thereof being signatures of the emails with the same subject;
determine a source of the emails with the same subject comprising the first predetermined character;
acquire, from the emails with the same subject, all the emails whose email source is the source of the emails with the same subject comprising the first predetermined character, and acquiring a first predetermined number of characters in last characters in the content of all the emails; and
compare the first predetermined number of characters of the acquired plurality of emails, and determine, according to a comparison result, the same character in the first predetermined number of characters of the plurality of emails as the signatures of the plurality of emails.

11. A non-transitory computer-readable storage medium storing executable instructions that, when executed by an electronic device, cause the electronic device to:
determine an original subject of an email in a predetermined file folder of an email account, the original subject being a subject of an original email corresponding to the email;
determine a plurality of emails with the same original subject to be emails with the same subject, such that the emails with the same subject are viewed under the same directory; and
determine signatures of the emails with the same subject from email content of the emails with the same subject, to remove the signatures of the emails with the same subject when displaying the emails with the same subject.
